(19) United States
(12) Patent Application Publication
(10) Pub. No.: US 2025/0267104 A1
(43) Pub. Date: Aug. 21, 2025

(54) RECLASSIFICATION AND PRIORITY QUEUE CONTROL

(71) Applicant: Charter Communications Operating, LLC, St. Louis, MO (US)

(72) Inventors: Hany A. Heikal, Aurora, CO (US); Mohamed Daoud, Englewood, CO (US)

(21) Appl. No.: 18/442,680

(22) Filed: Feb. 15, 2024

(51) Int. Cl. H04L 47/2441; H04L 43/0864

(52) U.S. Cl. CPC H04L 47/2441; H04L 43/0864

(57) ABSTRACT

A system as discussed herein includes communication management hardware. The communication management hardware: receives a first data packet including a first data payload, the first data packet transmitted for delivery to a destination network address; determines a first latency classification assigned to the first data packet; assigns a second latency classification to the first data packet as a substitute to the first latency classification; and forwards the first data packet for delivery to the destination network address in accordance with the second latency classification.

### BACKGROUND

L4S, or Low Latency, Low Loss, Scalable throughput, and Secure communication, is a conventional approach to managing Internet traffic and Quality of Service (QOS) to improve communication parameters such as performance, efficiency, and security.

In general, LAS has been primarily developed to address some limitations and challenges associated with traditional networking protocols, particularly in real-time applications, such as online gaming, video conferencing, and augmented reality/virtual reality (AR/VR) applications. In other words, one goal of conventional LAS data packet marking and forwarding is to reduce the amount of time that respective data packets wait in a queue before being transmitted to a corresponding destination.

### BRIEF DESCRIPTION

One downside of LAS is the temptation by a sender to request LAS handling for all types of traffic, which, in reality, can adversely impact the user experience of applications with varying sensitivity levels. Specifically, low-sensitive applications such as AR/VR and online gaming would suffer, as would queue-dependent applications like file downloads in a case of misuse. Presently, no effective mechanism exists for Internet Service Providers (ISPs) to designate which traffic should be designated as LAS and which should not.

To address the shortcomings of conventional techniques, a communication management resource as discussed herein can be configured to provide adjustments to the quality of service or, more specifically, latency as discussed herein of handling data packets. For example, the communication management resource can be configured to receive a first data packet including a first data payload, the first data packet transmitted for delivery to a destination network address of a corresponding communication device. The communication management resource determines a first latency classification assigned to the first data packet in any suitable manner. As a substitute to the first latency classification, the communication management resource assigns a second latency classification to the first data packet. In accordance with the second latency classification, the communication management resource then forwards the first data packet for delivery to the destination network address.

In accordance with further examples as discussed herein, the communication management resource can be configured to analyze one or more aspects of the first data packet. The communication management resource then selects the second latency classification as the substitute to the first latency classification based on the analysis of the first data packet. In one example, the communication management resource replaces the first tag value in the first data packet with a second tag value; the first tag value indicates the first latency classification; the second tag value indicates the second latency classification. The substitution of the first latency classification with the second latency classification changes latency handling of the corresponding first data packet.

Yet further, note that the first latency classification supports a first latency (i.e., the delay time of storing the first data packet before transmitting) of communicating the first data packet to the destination network address; the second latency classification supports a second latency of communicating the first data packet to the destination network address. The second latency may be less than the first latency. In such an instance, the operation of switching the latency assigned to the first data packet from the first latency to the second latency may decrease an amount of time it takes to communicate the respective first data packet to a recipient.

Conversely, the second latency (i.e., the delay time of storing the data packet before forwarding it) may be greater than the first latency. In such an instance, the operation of switching the latency assigned to the first data packet from the first latency to the second latency may increase the amount of time it takes to communicate the respective first data packet to a recipient.

In still further examples, forwarding of the first data packet by the communication management resource may include the communication management resource transmitting the first data packet to classifier hardware; the classifier hardware can be configured operative to store the first data packet in one of multiple queues depending upon the second latency classification assigned to the first data packet.

In accordance with further examples, assignment of the second latency classification to the data packet includes the communication management resource or other suitable entity substituting first bit information (tag value) in the first data packet with second bit information, the first bit information specifying the first latency classification, the second bit information (tag value) specifying the second latency classification.

In yet further examples as discussed herein, the communication management resource or other suitable entity can be configured to analyze first bit information in the first data packet. Assume that the first bit information specifies information such as a port number associated with the delivery of the first data packet to the destination network address. The port number indicating a particular type of data in the first data payload, the particular type assigned the second latency classification.

In still further examples, determination of the first latency classification assigned to the first data packet includes the communication management resource or other suitable entity inspecting a data field of the first data packet, the data field including bit information specifying the first latency classification.

Yet further, to support forwarding of the first data packet for delivery to the destination network address in accordance with the second latency classification, the communication management resource can be configured to store the first data packet in a second data delivery queue instead of a first data delivery queue. The second data delivery queue provides a different latency of storing the first data packet that the first data delivery queue. In one example, the first data delivery queue is configured to store first data packets assigned the first latency classification; the second data delivery queue is configured to store second data packets assigned the second latency classification.

Techniques as discussed herein are useful over conventional techniques. For example, one or more implementation of a communication management resource and corresponding operations as discussed herein provide better use of a respective wireless network to more efficiently convey data.

Note that any of the resources as discussed herein can include one or more computerized devices, mobile communication devices, sensors, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different embodiments as described herein.

Yet other embodiments herein include software programs to perform the steps and operations summarized above and disclosed in detail below. One such embodiment comprises a computer program product including a non-transitory computer-readable storage medium or any computer readable hardware storage medium on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, embodiments herein are directed to a method, system, computer program product, etc., that supports operations as discussed herein.

One embodiment includes computer readable storage hardware having instructions stored thereon. The instructions, when executed by corresponding computer processor hardware, cause the computer processor hardware (such as one or more co-located or disparately processor devices or hardware) to: receive a first data packet including a first data payload, the first data packet transmitted for delivery to a destination network address; determine a first latency classification assigned to the first data packet; assign a second latency classification to the first data packet as a substitute to the first latency classification; and forward the first data packet for delivery to the destination network address in accordance with the second latency classification instead of the first latency classification.

The ordering of the steps above has been added for clarity sake. Note that any of the processing steps as discussed herein can be performed in any suitable order.

Other embodiments of the present disclosure include software programs and/or respective hardware to perform any of the method embodiment steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of controlling conveyance of data packets in a network environment. However, it should be noted that embodiments herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of embodiments herein (BRIEF DESCRIPTION OF EMBODIMENTS) purposefully does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), the reader is directed to the Detailed Description section (which is a summary of embodiments) and corresponding figures of the present disclosure as further discussed below.

### BRIEF DESCRIPTION OF THE DRAWINGS

FIG. 1 is an example diagram illustrating a network environment implementing data packet flow management as discussed herein.

FIG. 2 is an example diagram illustrating data packet analysis as discussed herein.

FIG. 3 is an example diagram illustrating data packet analysis and modification as discussed herein.

FIG. 4 is an example diagram illustrating data packet analysis of the modification as discussed herein.

FIG. 5 is an example diagram illustrating different data forwarding control codes as discussed herein.

FIG. 6 is an example diagram illustrating mapping of port number information associated with a data packet to latency assignment information as discussed herein.

FIG. 7 is an example diagram illustrating mapping of data packet type information to latency assignment information as discussed herein.

FIG. 8 is an example diagram illustrating implementation of a cable modem system supporting dynamic queueing and corresponding forwarding of data packets as discussed herein.

FIG. 9 is an example diagram illustrating generation of multiple encapsulated data packets forwarded in a cable modem system as discussed herein.

FIG. 10 is an example diagram illustrating example computer hardware and software operable to execute operations as discussed herein.

FIG. 11 is an example diagram illustrating a method as discussed herein.

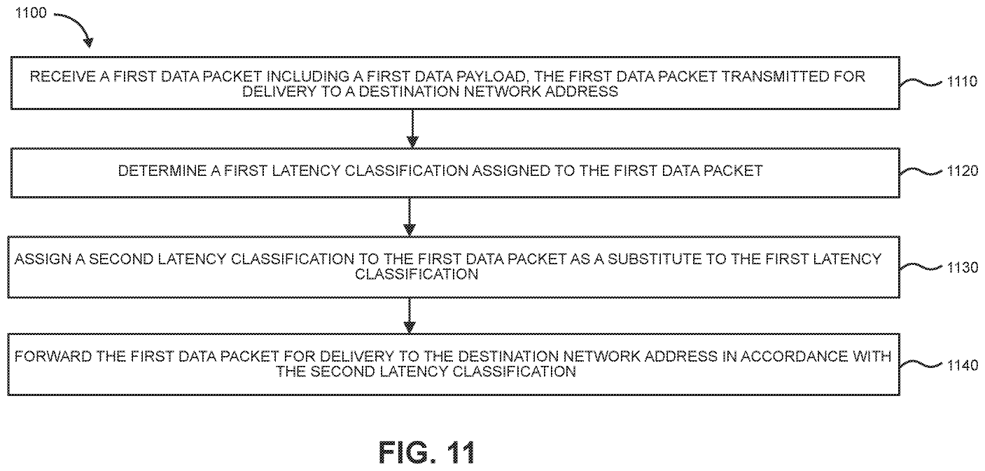

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DETAILED DESCRIPTION

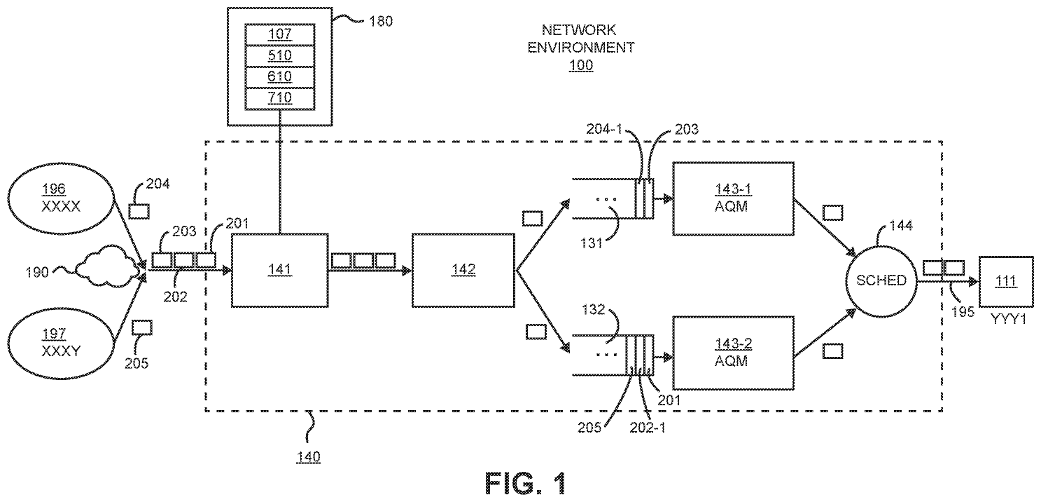

Now, more specifically, with reference to the drawings, FIG. 1 is an example diagram illustrating a network environment implementing data packet flow management as discussed herein.

As shown in FIG. 1, the network environment 100 includes application server resource 196, application server resource 197, network 190, and communication management resource 140. The communication management resource can be configured to include any suitable resources such as the controller 141, classifier 142, queue 131, queue 132, queue management resource 143-1, queue management resource 143-2, and scheduling manager 144.

Repository 180 can be configured to store any suitable information about managing and forwarding the corresponding received data packets such as model 107, mapping information 510, mapping information 610, mapping information 710, etc.

In one example, one or more instance of the mapping information 510, mapping information 610, mapping information 710, etc., are stored or captured by the model 107.

Note that the resources as discussed herein can be implemented via hardware, software, or a combination of hardware and software. For example, the communication management resource 140 can be implemented as communication management hardware, communication management software, or a combination of communication manager hardware and communication management software; the controller 141 can be implemented as controller hardware, controller software, or a combination of controller hardware and controller software; the classifier 142 can be implemented as classifier hardware, classifier software, or a combination of classifier hardware and classifier software; queue management resource 143-1 can be implemented as queue management hardware, queue management software, or a combination of queue management hardware and queue management software: queue management resource 143-2 can be implemented as queue management hardware, queue management software, or a combination of queue management hardware queue management software; scheduler 144 can be implemented as scheduler hardware, scheduler software, or a combination of scheduler hardware and scheduler software; and so on.

As further shown in this example, the application server 196 is assigned the source network address XXXX; the application server 197 is assigned the source network address XXXY.

The application server 196 generates one or more data packets for delivery over the network 190 and through the communication management resource 140 to the corresponding communication device 111 assigned the network address YYY1. The application server 197 generates one or more data packets for delivery over the network 190 to the corresponding communication device 111.

Each of the data packets generated by the application server 196 and the application server 197 can be tagged with a respective tag value indicating a desired latency of communicating the respective data packet from the communication management resource 140 to the communication device 111 or other suitable entity. As further discussed herein, the respective tag value or latency assignment information in the respective data packet can be used as a basis in which to determine which of the multiple queues to store the respective data packet for subsequent forwarding over the shared communication link 195 (such as parts of cable, optical fiber, hybrid fiber-coax, etc.).

In one example, the queue 131 is a so-called low latency queue; the queue 132 is a so-called high latency queue. Data packets (such as including data packet 203) in the queue 131 are transmitted over the shared communication link 195 with less latency than data packets in the queue 132. In other words, the queue management resource 143-1 can be configured to monitor presence of data packets such as the data packet 203 stored in the queue 131. Each data packet stored in the corresponding queue 131 can be assigned a timestamp value indicating a time in which the corresponding data packet was stored in the queue 131. The queue management resource 143-1 and corresponding scheduler 144 ensure that each data packet stored in the queue 131 resides in the queue 131 for less than maximum latency time T1 (such as 50 milliseconds or other suitable value) such as a low latency time threshold level. Such operations of forwarding the respective data packets in the queue 131 reduce a respective latency associated with forwarding the respective data packets to the destination 111. In other words, the schedule 144 forwards the respective data packets in the queue 131 so that they are not stored in the queue 131 longer than the maximum latency time T1.

Additionally, data packets (such as including data packet 201, 202-1, 205, etc.) in the queue 132 are transmitted over the shared communication link 195 with higher latency than the data packets in the queue 131. In other words, the queue management resource 143-1 can be configured to monitor presence of the data packets stored in the queue 132. The queue management resource 143-21 and corresponding scheduler 144 ensure that each data packet stored in the queue 132 resides in the queue 132 for less than maximum latency time T2 (such as 500 milliseconds or other suitable value) such as a high latency time threshold level. Such operations of forwarding the respective data packets in the queue 132 reduce a respective latency associated with forwarding the respective data packets to the destination 111. In other words, the schedule 144 forwards the respective data packets in the queue 132 so that they are not stored in the queue 132 longer than the maximum latency time T2.

In accordance with a further example, the controller 141 receives the data packet 201 from the application server 196 in response to the application server 196 transmitting the corresponding data packet 201 to the communication device 111. In other words, the first data packet 201 is transmitted for delivery to the communication device 121 assigned the destination network address YYY1. Further in this example, the controller 141 receives and analyzes the data packet 201. Based on the analysis, the controller 141 determines that the application server 196 generated the respective data packet 201 with a tag value indicating a second latency classification (such as indicating that data packet 201 is assigned a higher latency). Further, based on the analysis of the data in any manner as discussed herein using one or more of model 107, mapping information 510, mapping information 610, mapping information 710, etc., the controller 141 determines that the data packet 201 is properly assigned a higher latency. In such an instance, the controller 140 forwards the data packet 201 (such as unmodified) to the classifier 142. Via inspection, the classifier 142 determines that a respective tag value in the data packet 201 indicates a high latency classification. In response to detecting this condition of data packet 201 being assigned a high latency classification, the classifier 142 stores the data packet 201 in the queue 132.

As further shown, the controller 141 receives the data packet 202 from the application server 196 in response to the application server 196 transmitting corresponding data packet 202 to the communication device 111. In other words, the data packet 202 is transmitted for delivery from the application server 196 to the destination network address YYY1. Further in this example, the controller 141 receives and analyzes the data packet 202. Based on the analysis of the data packet 202, the controller 141 determines that the data packet 202 is improperly assigned a low latency delivery classification. In such an instance, the controller 141 modifies the corresponding data packet 202 to produce the data packet 202-1 for storage in the queue 132 instead of the queue 131. For example, the controller 141 determines that a respective tag value in the data packet 202 improperly indicates a low latency classification. In response to detecting the data packet 202 should be tagged with a high latency classification instead of low latency classification, the controller 141 modifies the data packet 202 with substitute tag value (high latency classification) to produce the data packet 202-1. Modification of the received data packet 202 into the data packet 202-1 ensures that the classifier 142 stores the modified data packet 202-1 in the queue 132 instead of the queue 131.

As further shown, the controller 141 receives the data packet 204 from the application server 196 in response to the application server 196 transmitting corresponding data packet 204 to the communication device 111. In other words, the data packet 204 is transmitted for delivery from the application server 196 to the destination network address YYY1. Further in this example, the controller 141 receives and analyzes the data packet 204. Based on the analysis of the data packet 204, the controller 141 determines that the data packet 204 is improperly assigned a high latency delivery classification. In such an instance, the controller 141 modifies the corresponding data packet 204 to produce the data packet 204-1 for storage in the queue 131 instead of the queue 132. More specifically, the controller 141 determines that a respective tag value in the data packet 204 improperly indicates a high latency classification. In response to detecting the data packet 204 should be tagged with a low latency classification instead of high latency classification, the controller 141 modifies the data packet 204 with substitute tag value (low latency classification) to produce the data packet 204-1. This ensures that the classifier 142 stores the modified data packet 204-1 in the queue 131 instead of the queue 132.

Additional details of modifying the data packets or not modifying the data packets as further discussed below.

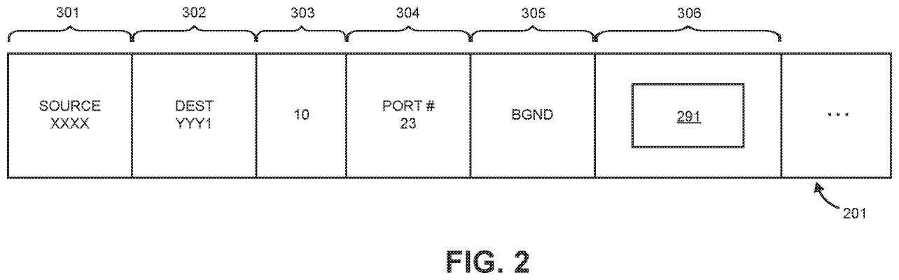

FIG. 2 is an example diagram illustrating data packet analysis and non-modification as discussed herein.

As shown in this example, the data packet 201 generated by and communicated from the application server 196 over the network 190 to the controller 141 includes a source network address of XXXX stored in the data field 301, destination network address YYY1 stored in the data field 302, data bit tag value=10 stored in the data field 303, port #23 stored in the data field 304, data type of BGND stored in the field 305, and data payload 291 stored in the data field 306.

The source network address XXXX in the data field 301 indicates the corresponding identity of the application server 196 generating and transmitting the respective data packet 201 to the mobile communication device 111.

The destination network address YYY1 in the data field 302 indicates the identity of the communication device 111 to which the data packet 201 is transmitted.

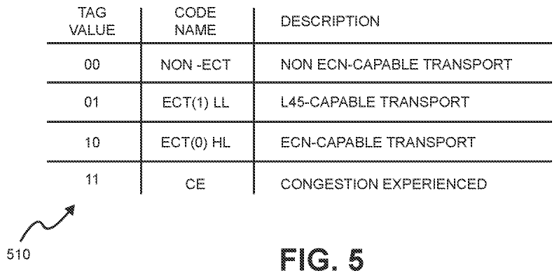

The tag value 10 (indicating L4S-capable transport) in the data field 303 indicates that the data packet 201 is assigned a higher latency classification. See FIG. 5 where mapping of the tag value bits 01 to the high latency classification.

The port #value 23 in data field 304 indicates the corresponding port of an application executed on the communication device 111 to which the data payload 291 (in data field 306) conveyed by the data packet 201 is communicated to the communication device 111. In one example, the port #value 23 indicates the type of data being transmitted by the data payload 291. In other words, the port number of the application indicates the type of data in the data payload 291.

As previously discussed, the controller 141 can be configured to analyze the data in one or more respective data fields of the data packet 201 to determine if the marking of the data packet as a high latency data packet (in data field 303) is appropriate or correct.

The controller 141 can be configured to implement any suitable method to determine whether the marking of the data packet with a high latency assignment is correct or not. For example, as previously discussed, the controller 141 can be configured to access the map information 510 in FIG. 5 to determine that the tag value of 01 in the data field 303 indicates that the data packet 201 is assigned a high latency classification (such as destined for storage in the queue 132).

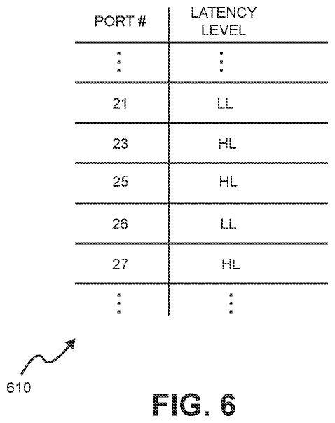

After determining the originally assigned high latency classification assignment, if desired, the controller 141 can be configured to implement the mapping information 610 in FIG. 6 to map the port value 23 in data field 304 to the corresponding appropriate latency classification HL. Such a mapping in the mapping information 610 confirms the type of data in the data packet 291 and that the data packet 201 is properly assigned the high latency classification as indicated by the tag value 10 stored in the data field 303.

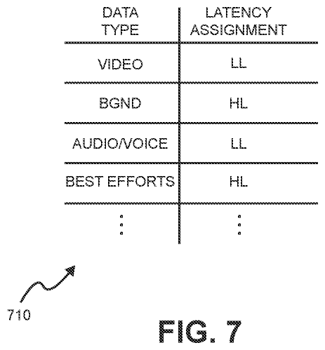

Additionally, or alternatively, the controller 141 can be configured to implement the mapping information 710 in FIG. 7 to map the data type information (BGND) stored in the data field 305 of the data packet 201 to the corresponding appropriate latency classification HL. Recall that the data type information in the data field 305 indicates the type of data (such as low urgency data) being transmitted by the data payload 291. Such a mapping confirms that the data packet 201 is properly assigned the high latency classification as indicated by the tag value 10 stored in the data field 303 of the data packet 201.

Note again that the controller 141 can be configured to implement any method to determine that the data packet 201 is properly classified as a high latency classification.

In such an instance, after confirming or verifying that the data packet 201 is properly assigned the high latency classification as originally marked by the data field 303, the controller 141 forwards the corresponding data packet 201 to the classifier 142. The classifier 142 determines (such as from information received from the controller 141 or the information such as data field 303 stored in the data packet 201) that the data packet 201 is assigned a high latency classification to be stored in the queue 132 supporting the high latency data packets. Thus, the classifier 142 stores the data packet 201 in the queue 132 for subsequent delivery over the shared communication link 195 by the scheduler 144.

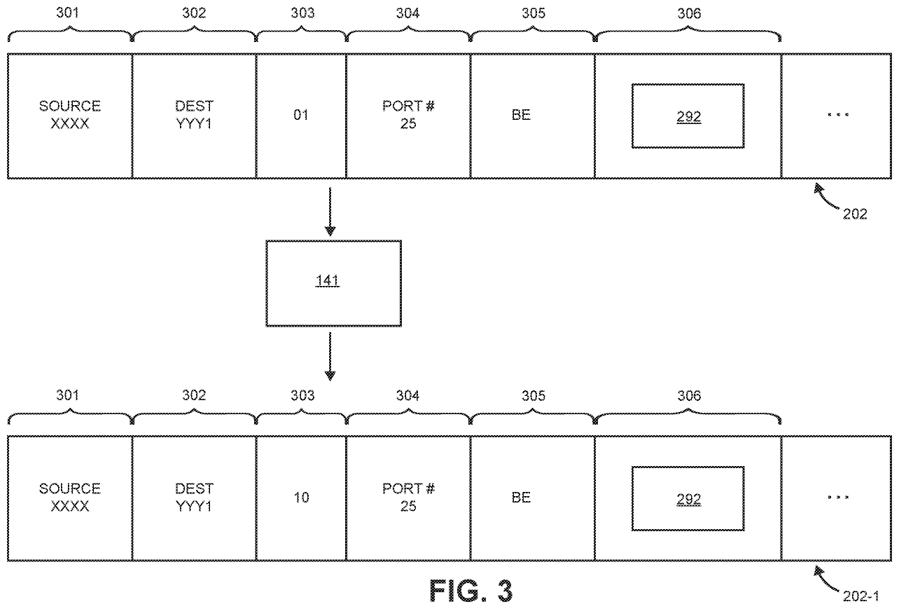

FIG. 3 is an example diagram illustrating data packet analysis of the modification as discussed herein.

As shown in this example, the data packet 202 generated by and communicated from the application server 196 or other suitable entity over the network 190 to the controller 141 includes a source network address of XXXX stored in the data field 301, destination network address YYY1 stored in the data field 302, data bit tag value=01 stored in the data field 303, port #25 stored in the data field 304, data type value of BEST EFFORTS (BE) stored in the data field 305, and data payload 292 stored in the data field 306.

The source network address XXXX in the data field 301 indicates the corresponding identity of the application server 196 generating and transmitting the respective data packet 202.

The destination network address YYY1 in the data field 302 indicates the identity of the communication device 111 to which the data packet 202 is transmitted.

The tag value 01 in the data field 303 of data packet 202 indicates that the data packet 202 is originally assigned a lower latency classification by the application server 196. See FIG. 5 where the tag value bits 01 map to the low latency classification.

The port #value 25 in data field 304 of data packet 202 indicates the corresponding port of an software application executed on the communication device 111 to which the data payload 292 (in data field 306 of data packet 202) conveyed by the data packet 202 is communicated to the communication device 111.

As previously discussed, the controller 141 can be configured to analyze the data in one or more respective data fields of the data packet 202 to determine if the marking of the data packet as a low latency data packet (in data field 303 with the value 01) is appropriate or correct.

A similar manner as previously discussed, the controller 141 can be configured to implement any suitable method to determine whether the marking of the data packet 202 is correct or not.

For example, as previously discussed, the controller 141 can be configured to access the map information 510 in FIG. 5 to determine that the tag value of 01 in the data field 303 indicates that the data packet 201 is assigned a low latency classification (such as destined for storage in the queue 131) for low latency transmission.

After determination of the original low latency classification assignment, if desired, the controller 141 can be configured to implement the mapping information 610 in FIG. 6 to map the port value 25 in data field 304 to the corresponding appropriate high latency classification HL. Such a mapping confirms that the data packet 202 is improperly assigned the low latency classification as indicated by the tag value 01 stored in the data field 303.

Additionally, or alternatively, note that the controller 141 can be configured to implement the mapping information 710 in FIG. 7 to map the data type information (BEST EFFORTS) stored in the data field 305 of the data packet 202 to the corresponding appropriate high latency classification HL. Recall that the data type information in the data field 305 indicates the type of data being transmitted by the data payload 291. Such a mapping confirms that the data packet 202 is improperly assigned the low latency classification as indicated by the tag value 01 stored in the data field 303.

Note again that the controller 141 can be configured to further implement any method to determine that the data packet 202 is properly classified as a high or low latency classification.

Rather than forwarding the data packet 202 to the classifier 142 for storage in the queue 132, the controller 141 modifies the data packet 202 to produce the data packet 202-1. In one example, modification of the data packet 202 includes changing the value in the data field 303 from the value 01 to the value 10, to indicate that the data packet 202-1 is assigned the high latency classification for storage in the queue 132.

In such an instance, after modifying the data packet 202, the controller 141 forwards the corresponding data packet 202-1 to the classifier 142. The classifier 142 determines (such as from information received from the controller 141 or the information such as data field 303 stored in the data packet 202-1) that the data packet 202-1 is to be stored in the queue 132 supporting the high latency data packets. Thus, the classifier 142 stores the data packet 202-1 in the queue 132 for subsequent delivery over the shared communication link by the scheduler 144. In this manner, the data packet 202 originally destined for storage in the queue 131 is instead stored in the queue 132.

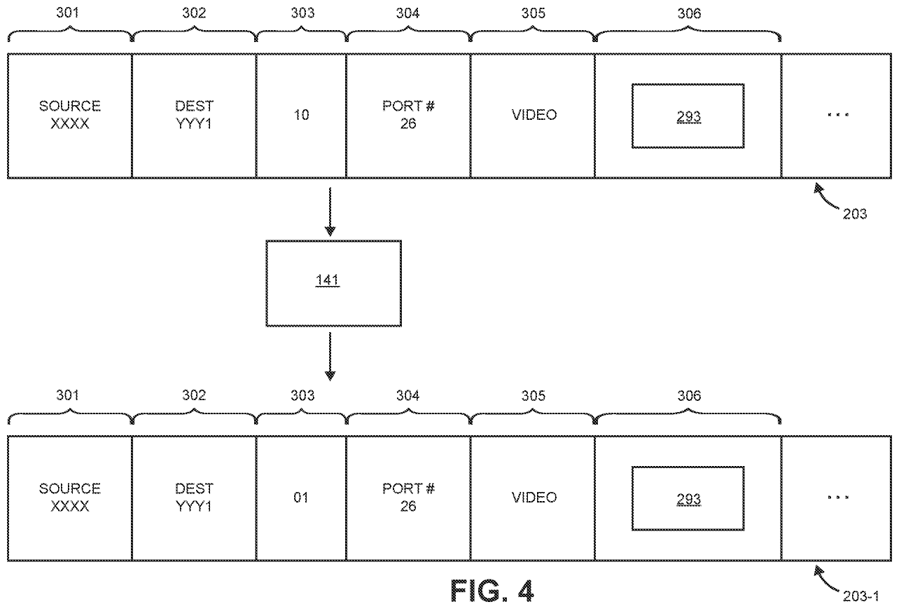

FIG. 4 is an example diagram illustrating different data forwarding control codes as discussed herein.

As shown in this example, the data packet 203 generated by and communicated from the application server 196 or other suitable entity over the network 190 to the controller 141 includes a source network address of XXXX stored in the data field 301, destination network address YYY1 stored in the data field 302, data bit tag value=10 stored in the data field 303, port #26 stored in the data field 304, data type of VIDEO stored in the data field 305, and data payload 293 stored in the data field 306.

The source network address XXXX in the data field 301 indicates the corresponding identity of the application server 196 generating and transmitting the respective data packet 203.

The destination network address YYY1 in the data field 302 indicates the identity of the communication device 111 to which the data packet 203 is transmitted.

The tag value 10 in the data field 303 of data packet 203 indicates that the data packet 203 is originally assigned a lower latency classification by the application server 196. See FIG. 5 where the tag value bits 10 map to the high latency classification.

The port #value 26 in data field 304 of data packet 203 indicates the corresponding port of an application executed on the communication device 111 to which the data payload 293 (in data field 306 of data packet 203) conveyed by the data packet 203 is communicated to the communication device 111.

As previously discussed, the controller 141 can be configured to analyze the data in one or more respective data fields of the data packet 203 to determine if the marking of the data packet as a high latency data packet (in data field 303 with the value 10) is appropriate or correct.

A similar manner as previously discussed, the controller 141 can be configured to implement any suitable method to determine whether the marking of the data packet 203 is correct or not.

For example, as previously discussed, the controller 141 can be configured to access the map information 510 in FIG. 5 to determine that the tag value of 10 in the data field 303 indicates that the data packet 201 is assigned a high latency classification (such as destined for storage in the queue 132) for high latency transmission.

After determination of the original high latency classification assignment, if desired, the controller 141 can be configured to implement the mapping information 610 in FIG. 6 to map the port value 26 in data field 304 to the corresponding appropriate low latency classification LL. Such a mapping confirms that the data packet 203 is improperly assigned the high latency classification as indicated by the tag value 10 stored in the data field 303.

Additionally, or alternatively, note that the controller 141 can be configured to implement the mapping information 710 in FIG. 7 to map the data type information (VIDEO) stored in the data field 305 of the data packet 203 to the corresponding appropriate low latency classification LL. Recall that the data type information in the data field 305 indicates the type of data being transmitted by the data payload 293. Such a mapping confirms that the data packet 203 is improperly assigned the high latency classification as indicated by the tag value 10 stored in the data field 303.

Note again that the controller 141 can be configured to further implement any method to determine that the data packet 203 is properly classified as a high or low latency classification.

Rather than forwarding the data packet 203 to the classifier 142 for storage in the queue 131, as previously discussed, the controller 141 modifies the data packet 203 to produce the data packet 203-1. In one example, modification of the data packet 203 includes changing the value in the data field 303 from the value 10 to the value 01 to indicate that the data packet 203-1 is assigned the low latency classification for storage in the queue 131.

In such an instance, after modifying the data packet 203, the controller 141 forwards the corresponding modified data packet 203-1 to the classifier 142. The classifier 142 determines (such as from information received from the controller 141 or the information such as data field 303 stored in the data packet 203-1) that the data packet 203-1 is to be stored in the queue 131 supporting the latency data packets. Thus, the classifier 142 stores the data packet 203-1 in the queue 131 for subsequent delivery over the shared communication link 195 by the scheduler 144. In this manner, the data packet 203 originally destined for storage in the queue 132 is instead stored in the queue 131 for subsequent transmission over the shared communication link 195.

Note further that any suitable rules stored in the model 107 or other control information stored in repository 180 can be used as a basis in which to forward the received data packets. For example, in one implementation, the communication management resource 140 and corresponding controller 141 can be configured to analyze a source that is transmitting a respective data packet. If desired, the controller 141 can be configured to default to modifying any data packets received from the source network address XXXX to a high latency classification or a low latency classification. As another example, the controller 141 can be configured to default to modifying any data packets destined for delivery to the network address YYY1 to a high latency classification or a low latency classification.

Accordingly, forwarding of the respective data packets can be based on any information found in the header data fields 301, 302, 303, 304, 305, etc.

Yet further, the controller 141 can be configured to analyze the data payload associated with a respective received data packet to determine a type of data being transmitted by the data packet. In such an instance, forwarding of the respective data packets can be based on analysis of the respective data payload of the data packet.

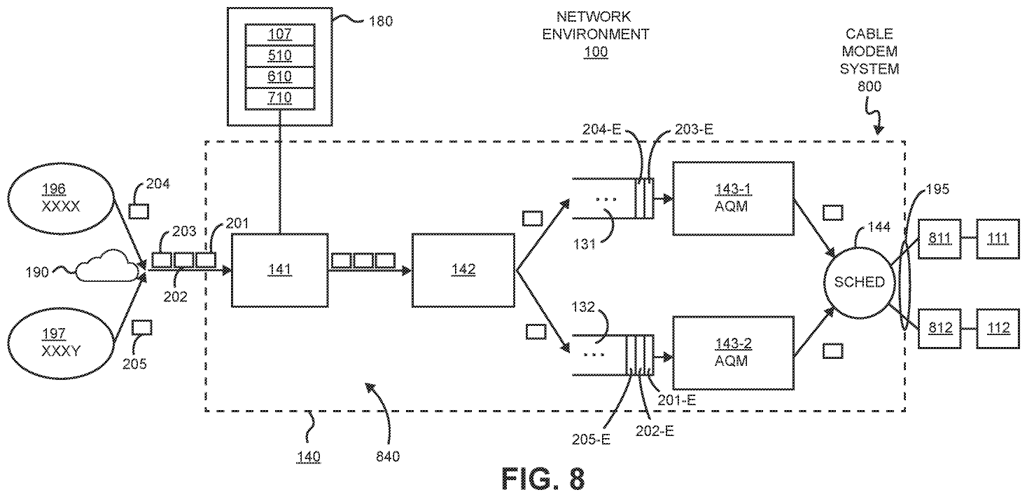

FIG. 8 is an example diagram illustrating implementation of a cable modem system supporting dynamic queuing and corresponding forwarding of data packets as discussed herein.

In one example, the communication management resource 140 is implemented as a cable modem termination system 840 associated with a cable modem system 800 such as supporting communications in accordance with DOCSIS (Data Over Cable Service Interface Specification) or any other suitable communication protocol. The cable modem termination system 840 can be configured to control conveyance of communications over the shared communication link 195 to multiple different cable modems including cable modem 811 such as in a first subscriber domain, cable modem 812 such as in a second subscriber domain, etc.

Each of the subscriber domains is provided service by a respective Internet service provider operating the cable modem system 800.

The combination of the cable modem termination system 840, shared communication link 195, and cable modem 811 support conveyance of communications between the network 190 and the mobile communication device 111.

Accordingly, the proposed solution as discussed herein introduces a new software component such as the communication management resource 140 executed in the cable modem termination system 840, which includes a controller 141 disposed in front of the classifier 142. As previously discussed, one function of the communication management resource 140 and corresponding components (such as controller 141, classifier 142, queue management resource 143-1, queue management resource 143-2, scheduler 144, etc.) is to ensure that the received communications 201, 202, 203, 204, 205, etc., are communicated over the shared communication link 195 in accordance with the appropriate latency.

In one example, the communication management resource 140 classifies and categorizes received internet traffic (such as communications or data packets 201, 202, 203, 204, 205, etc.) using machine learning and analysis. In one example, using machine learning, data packet classification and categorization by the communication management resource 140 includes applying various machine learning techniques to categorize and analyze the data flowing through computer networks to produce the model 107.

In one example, the operations of the communication management resource 140 implementing Machine Learning (ML) and Artificial Intelligence (AI) to classify network traffic at a Cable Modem Termination System (CMTS) node include:

### 1. Data Collection:

Example: Collect packet capture data from the CMTS node, including details such as source and destination IP addresses, port numbers, and packet payload. This dataset will serve as the basis for training and testing the traffic classification model 107.

### 2. Data Preprocessing:

Example: Remove duplicate packets and handle missing values in the packet capture data. Normalize packet sizes and convert timestamps of receiving the data packets into a consistent format for analysis.

### 3. Feature Engineering:

Example: Extract relevant features from the packet capture data, such as packet size distributions, inter-arrival times between packets, and the presence of specific protocol headers (e.g., HTTP, DNS).

### 4. Data Labeling:

Example: Manually label the collected data with traffic type categories, such as “VoIP calls,” “Video streaming,” or “File downloads.”

### 5. Splitting the Data:

Example: Divide the labeled dataset into three subsets: a training set (70%), a validation set (15%), and a test set (15%). These subsets will be used to train, fine-tune, and evaluate the machine learning model 107, respectively.

### 6. Model Selection:

Example: Choose an appropriate ML model 107, such as a decision tree, a Random Forest, or a deep neural network, to classify network traffic based on the extracted features.

### 7. Model Training:

Example: Train the selected ML model 107 using the training dataset, allowing it to learn patterns and relationships between the extracted features and traffic types.

### 8. Hyperparameter Tuning:

Example: Experiment with various hyperparameters, such as the maximum depth of a decision tree or the number of layers in a neural network, using the validation dataset to optimize the model's performance.

### 9. Model Evaluation:

Example: Assess the model's accuracy and effectiveness in classifying network traffic by evaluating it on the test dataset. Metrics like accuracy, precision, recall, and F1-score can be calculated to gauge performance.

### 10. Model Deployment:

Example: Implement the trained ML model 107 within the CMTS node's network infrastructure to classify incoming traffic in real-time. For instance, the model can classify network packets as “VoIP traffic” or “Video streaming traffic” based on their features.

### 11. Monitoring and Maintenance:

Example: Continuously monitor the model's performance in the live network environment. If there are changes in network traffic patterns, such as the emergence of a new application or protocol, retrain the model 107 with updated data to ensure accurate classification.

Example Scenario: Use ML/AI to classify network traffic at a CMTS node. Collect historical network traffic data over several months, including packet-level information and labels indicating the traffic type (e.g., web browsing, video streaming, online gaming).

Preprocess the data by cleaning it and normalizing packet sizes. Engineer features like packet size distributions, average inter-packet arrival times, and the presence of specific keywords in the payload.

Split the data into training, validation, and test sets. Choose a neural network architecture suitable for sequence data and train it using the training data. Experiment with different learning rates and batch sizes and find the best hyperparameters using the validation set.

After achieving satisfactory performance in generation of the corresponding model 107, the controller 141 implements the trained model 107 at the CMTS node (such as 840) to classify incoming network traffic in real-time in a manner as previously discussed. The communication management resource 140 can be configured to regularly monitor an accuracy of the model 107 and another forwarding rules stored in the repository 180 retrain it with new data if the network's traffic patterns change significantly.

This example demonstrates the general process of using ML/AI for network traffic classification, but the specific implementation details can vary depending on the dataset, model 107 choice, and network environment.

Accordingly, as discussed herein, the Internet service provider operating the cable modem system 800 can be provided the ability to overwrite the LA settings for any traffic types, where rules for overwriting latency assignment settings is configurable by the Internet service provider.

The evolution of applications that require high throughput and low latency simultaneously has emerged. For example, HD/4K video, holographic video streaming, Augmented Reality/Virtual Reality, Robot remote control, and Cloud Gaming. All these traffic types require LAS to be activated. As previously discussed, the Internet service provider may activate or deactivate L4S settings for the received data packets.

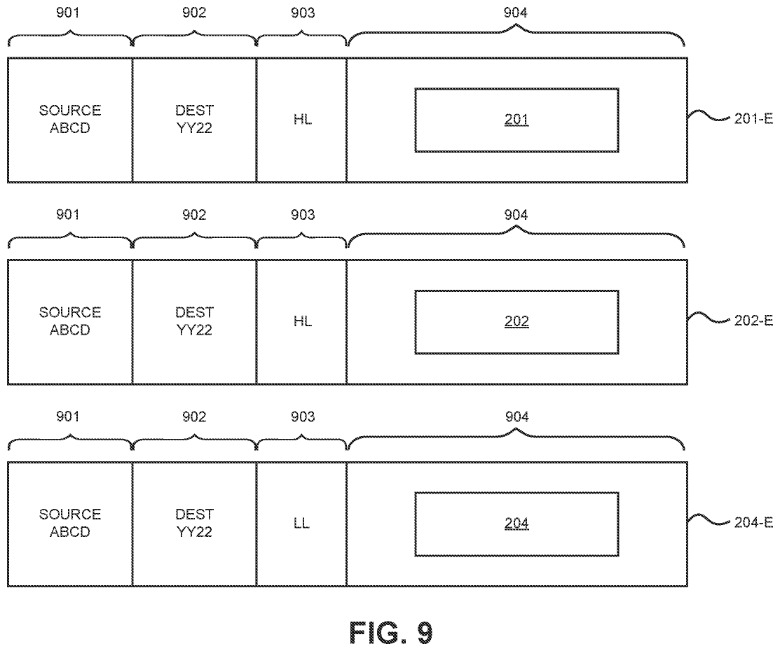

Further, as previously discussed, the rest of the traffic types can deactivate the L4S if activated first, allowing the ISP to protect their assets (such as available bandwidth to communicate data from the cable modem termination system 840 to the downstream cable modems). More specific details of communicating respective data packets over the cable modem system 800 are discussed in following FIG. 9.

FIG. 9 is an example diagram illustrating generation of an encapsulated data packet forwarded in a cable modem system as discussed herein.

In a similar manner as previously discussed, the controller 140 can be configured to analyze respective data packets received from one or more sources over the network 190. In this example, the controller 140 encapsulates the received data packets for transmission over a respective cable modem system 800.

More specifically, as shown in FIG. 9, and with further reference to the other drawings, the controller 140 associated with the cable modem system 800 produces the encapsulated data packet 201-E based upon reception of the data packet 201. As previously discussed, the original data packet 201 is properly marked with a high latency assignment value. In such an instance, based on the analysis as previously discussed in FIG. 2 (such as verification that the received data packet 201 is properly marked as a high latency data packet), the controller 141 produces the encapsulated data packet 201-E to include the original data packet 201 as well as additional header information in the data fields 901, 902, 903.

In this example, the original data packet 201 communicated to the communication device 111 is stored in the data field 904 of the encapsulated data packet 201-E. Additionally, the controller 141 produces the data packet 201-E to include the source network address ABCD (i.e., network address assigned to the cable modem termination system 840) in the data field 901. If desired, the controller 141 can be configured to produce the encapsulated data packet 201-need to include any suitable source network address such as ABCD or other suitable value. Further, the controller 141 produces the data packet 201-E to include the destination network address YY22 (i.e., network address assigned to the cable modem 811) in the data field 902. The controller 141 further produces the data packet 201-E to include a tag value HL in the data field 903. In this example, note that the tag value HL in the data field 903 provides notification to the classifier 142 that the data packet 201-E should be stored in the queue 132 (that is the queue 4 high latency data packets) for subsequent transmission by the scheduler 144 over the shared communication link 195 from the cable modem termination system 840 to the cable modem 811.

In one example, upon receipt, the cable modem 811 removes the encapsulation portion of the data packet 201-E to retrieve the original data packet 201. In accordance with the destination network address as specified by the data packet 201, the cable modem 811 communicates the retrieved data packet 201 to the mobile communication device 111.

Thus, in this case, the original data packet 201 indicated a high latency classification which was the same assigned classification associated with the corresponding encapsulated data packet 201-E as indicated in the data field 903 of the encapsulated data packet 201-E.

As further shown in FIG. 9, and with further reference to the other drawings, the controller 140 produces the encapsulated data packet 202-E based upon reception of the data packet 202. As previously discussed, the data packet 202 is improperly marked with a low latency assignment value it should be marked with a high latency assignment value. In such an instance, based on the analysis as previously discussed in FIG. 2 (such as determination that the received data packet 202 is improperly marked as a low latency data packet), the controller 141 produces the encapsulated data packet 202-E to include the original data packet 202 as well as additional header information in the corresponding data fields 901, 902, 903, for forwarding.

For example, the original data packet 202 communicated to the communication device 111 is stored in the data field 904 of the encapsulated data packet 202-E. Additionally, the controller 141 produces the data packet 202-E to include the source network address ABCD (i.e., network address assigned to the cable modem termination system 840) in the data field 901. The controller 141 produces the data packet 202-E to include the destination network address YY22 (i.e., network address assigned to the cable modem 811) in the data field 902. The controller 141 further produces the data packet 202-E to include a tag value HL in the data field 903. Note that the tag value HL provides notification to the classifier 142 that the data packet 202-E should be stored in the queue 132 (that is queue for high latency data packets) for subsequent transmission by the scheduler 144 over the shared communication link 195 to the cable modem 811.

In one example, upon forwarding of the data packet to its destination, the cable modem 811 removes the encapsulation portion of the data packet 202-E to retrieve the original data packet 202. In accordance with the destination network address as specified by the data packet 202, the cable modem 811 communicates the retrieved data packet 202 to the mobile communication device 111.

Thus, in this case, the data field 303 of the original data packet 202 indicated a low latency classification which was different than the latency assignment classification as indicated by the value HL in the data field 903 of the encapsulated data packet 202-E. In such an instance, the data packet 202 indicates low latency assignment for forwarding while the encapsulated data packet 202-E indicates the appropriate or correct latency assignment value of HL for storage in the queue 132. If desired, the controller 141 can be configured to produce the encapsulated data packet 202-E to include the modified data packet 202-1 (as an alternative to the data packet 202) in the data field 904 of the data packet 202-E.

Accordingly, this example illustrates how an original data packet 202 can be processed and verified prior to forwarding of the data packet as an encapsulated data packet over a respective cable modem system 800.

As further shown in FIG. 9, and with further reference to the other drawings, the controller 140 produces the encapsulated data packet 204-E based upon reception of the data packet 204. As previously discussed, the data field 303 of the data packet 204 is improperly marked with a high latency assignment value. In such an instance, based on the analysis as previously discussed in FIG. 2 (such as determination that the received data packet 204 is improperly marked as a high latency data packet), the controller 141 produces the encapsulated data packet 204-E to include the original data packet 204 as well as additional header information in the corresponding data fields 901, 902, 903, for forwarding.

For example, the original data packet 204 communicated to the communication device 111 is stored in the data field 904 of the encapsulated data packet 204-E. Additionally, the controller 141 produces the data packet 204-E to include the source network address ABCD (i.e., network address assigned to the cable modem termination system 840) in the data field 901. The controller 141 produces the data packet 204-E to include the destination network address YY22 (i.e., network address assigned to the cable modem 811) in the data field 902. The controller 141 further produces the data packet 204-E to include a tag value LL in the data field 903. Note that the tag value LL provides notification to the classifier 142 that the data packet 204-E should be stored in the queue 131 (that is queue for low latency data packets) for subsequent transmission by the scheduler 144 over the shared communication link 195 to the cable modem 811.

In one example, upon forwarding of the data packet 204-E to the destination, the cable modem 811 removes the encapsulation portion of the data packet 204-E to retrieve the original data packet 204. In accordance with the destination network address as specified by the data packet 204, the cable modem 811 communicates the retrieved data packet 204 to the mobile communication device 111.

Thus, in this case, the original data packet 204 indicated a high latency classification which was different than the latency assignment classification as indicated by the value LL in the data field 903 of the encapsulated data packet 204-E. In such an instance, the data packet 204 indicates high latency assignment for forwarding while the encapsulated data packet 204-E indicates the appropriate or correct latency assignment value of LL for storage in the queue 131. If desired, the controller 141 can be configured to produce the encapsulated data packet 204-E to include the modified data packet 204-1 in the data field 904 of the data packet 204-E.

Accordingly, this example illustrates how an original data packet 204 can be processed and verified prior to forwarding of the data packet as an encapsulated data packet over a respective cable modem termination system 800. The generation of the appropriate latency assignment information for storage in the encapsulated data packets ensures that the cable modem system 800 is not improperly bogged down by this marked data packets that it happens the received or conveyance in a downlink to one or more cable modems 811, 812, etc. In other words, if the cable modem termination system 840 simply used markings in the originally received data packets, the blind forwarding of those data packets in the service provider network operating the cable modem system 800 may be undesirable because the packets may be improperly marked. As discussed during, the verification and potential reassignment of latency assignment information to the received data packets to produce encapsulated data packets ensures better use of the cable modem system 800 and corresponding available resources such as shared communication link 195, etc.

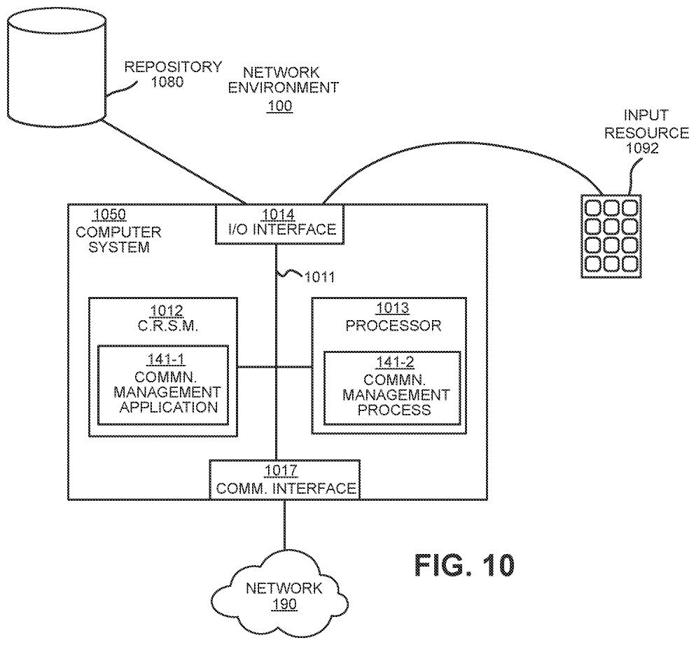

FIG. 10 is an example block diagram of a computer system for implementing any of the operations as previously discussed according to embodiments herein.

Note that any of the resources (such as communication management resource 140, communication management resource 141, classifier 142, queue management resource 143-1, queue management resource 143-2, scheduler 144, communication device 111, cable modem termination system 840, cable modem 811, cable modem 812, etc.) as discussed herein can be configured to include computer processor hardware and/or corresponding executable instructions to carry out the different operations as discussed herein.

For example, as shown, computer system 1050 of the present example includes interconnect 1011 coupling computer readable storage media 1012 such as a non-transitory type of media or computer readable storage hardware (which can be any suitable type of resource in which digital information can be stored and or retrieved), a processor 1013 (computer processor hardware), I/O interface 1014, and a communications interface 1017.

I/O interface(s) 1014 supports connectivity to repository 1080 and input resource 1092.

Computer readable storage medium 1012 can be any hardware storage device such as memory, optical storage, hard drive, floppy disk, etc. In one embodiment, the computer readable storage medium 1012 stores instructions and/or data.

As shown, computer readable storage media 1012 can be encoded with communication management application 140-1 in a respective one or more network nodes to carry out any of the operations as discussed herein.

During operation of one example, processor 1013 accesses computer readable storage media 1012 via the use of interconnect 1011 in order to launch, run, execute, interpret or otherwise perform the instructions in management application 140-1 stored on computer readable storage medium 1012. Execution of the management application 140-1 produces management process 140-2 to carry out any of the operations and/or processes as discussed herein.

Those skilled in the art will understand that the computer system 1050 can include other processes and/or software and hardware components, such as an operating system that controls allocation and use of hardware resources to execute the management application 140-1.

In accordance with different embodiments, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 1050 may reside at any location or can be included in any suitable resource in any network environment to implement functionality as discussed herein.

Functionality supported by the different resources will now be discussed via flowchart 1000 in FIG. 10. Note that the steps in the flowcharts below can be executed in any suitable order.

FIG. 10 is a flowchart 1000 illustrating an example method according to embodiments herein. Note that there will be some overlap with respect to concepts as discussed above.

In processing operation 1010, the communication management resource 140 receives a first data packet including a first data payload. The first data packet is transmitted from a source such as a server resource or other suitable entity for delivery to a destination network address.

In processing operation 1020, the communication management resource 140 determines a first latency classification assigned to the first data packet.

In processing operation 1030, the communication management resource 140 assigns a second latency classification to the first data packet as a substitute to the first latency classification.

In processing operation 1040, the communication management resource 140 forwards the first data packet for delivery to the destination network address in accordance with the second latency classification.

Note again that techniques herein are well suited to facilitate wireless connectivity in accordance with different available wireless services. However, it should be noted that embodiments herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this example has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

We claim:

1. A method comprising:
receiving a first data packet including a first data payload, the first data packet transmitted for delivery to a destination network address;
determining a first latency classification assigned to the first data packet;
assigning a second latency classification to the first data packet as a substitute to the first latency classification; and
forwarding the first data packet for delivery to the destination network address in accordance with the second latency classification.

2. The method as in claim 1 further comprising:
analyzing the first data packet; and
selecting the second latency classification as the substitute to the first latency classification based on the analysis of the first data packet.

3. The method as in claim 2 further comprising:
replacing a first tag value in the first data packet with a second tag value, the first tag value indicating the first latency classification, the second tag value indicating the second latency classification.

4. The method as in claim 1, wherein the first latency classification supports a first latency of communicating the first data packet to the destination network address;
wherein the second latency classification supports a second latency of communicating the first data packet to the destination network address; and
wherein the second latency is less than the first latency.

5. The method as in claim 1, wherein the first latency classification supports a first latency of communicating the first data packet to the destination network address;
wherein the second latency classification supports a second latency of communicating the first data packet to the destination network address; and
wherein the second latency is greater than the first latency.

6. The method as in claim 1, wherein forwarding the first data packet includes:
transmitting the first data packet to classifier hardware operative to store the first data packet in one of multiple queues depending upon the second latency classification assigned to the first data packet.

7. The method as in claim 1, wherein the assigning of the second latency classification to the data packet includes:
substituting first bit information in the first data packet with second bit information, the first bit information specifying the first latency classification, the second bit information specifying the second latency classification.

8. The method as in claim 1 further comprising:
analyzing first bit information in the first data packet, the first bit information specifying a port number associated with the delivery of the first data packet to the destination network address, the port number indicating a particular type of data in the first data payload, the particular type assigned the second latency classification.

9. The method as in claim 1, wherein determining the first latency classification assigned to the data packet includes:
inspecting a data field of the first data packet, the data field including bit information specifying the first latency classification.

10. The method as in claim 1, wherein forwarding the first data packet for delivery to the destination network address in accordance with the second latency classification includes: storing the first data packet in a second data delivery queue instead of a first data delivery queue;
wherein the first data delivery queue is configured to store first data packets assigned the first latency classification; and
wherein the second data delivery queue is configured to store second data packets assigned the second latency classification.

11. A system comprising:
communication management hardware operative to:
receive a first data packet including a first data payload, the first data packet transmitted for delivery to a destination network address;
determine a first latency classification assigned to the first data packet;
assign a second latency classification to the first data packet as a substitute to the first latency classification; and
forward the first data packet for delivery to the destination network address in accordance with the second latency classification.

12. The system as in claim 11, wherein the communication management hardware is further operative to:
analyze the first data packet; and
select the second latency classification as the substitute to the first latency classification based on the analysis of the first data packet.

13. The system as in claim 12, wherein the communication management hardware is further operative to:
replace a first tag value in the first data packet with a second tag value, the first tag value indicating the first latency classification, the second tag value indicating the second latency classification.

14. The system as in claim 11, wherein the first latency classification supports a first latency of communicating the first data packet to the destination network address;
wherein the second latency classification supports a second latency of communicating the first data packet to the destination network address; and
wherein the second latency is less than the first latency.

15. The system as in claim 11, wherein the first latency classification supports a first latency of communicating the first data packet to the destination network address;
wherein the second latency classification supports a second latency of communicating the first data packet to the destination network address; and
wherein the second latency is greater than the first latency.

16. The system as in claim 11, wherein the communication management hardware is further operative to:
transmit the first data packet to classifier hardware operative to store the first data packet in one of multiple queues depending upon the second latency classification assigned to the first data packet.

17. The system as in claim 11, wherein the communication management hardware is further operative to:
substitute first bit information in the first data packet with second bit information, the first bit information specifying the first latency classification, the second bit information specifying the second latency classification.

18. The system as in claim 11, wherein the communication management hardware is further operative to:
analyze first bit information in the first data packet, the first bit information specifying a port number associated with the delivery of the first data packet to the destination network address, the port number indicating a particular type of data in the first data payload, the particular type assigned the second latency classification.

19. The system as in claim 11, wherein the communication management hardware is further operative to:
inspect a data field of the first data packet, the data field including bit information specifying the first latency classification.

20. The system as in claim 11, wherein the communication management hardware is further operative to: store the first data packet in a second data delivery queue instead of a first data delivery queue;
wherein the first data delivery queue is configured to store first data packets assigned the first latency classification; and
wherein the second data delivery queue is configured to store second data packets assigned the second latency classification.

21. Computer-readable storage hardware having instructions stored thereon, the instructions, when carried out by computer processor hardware, cause the computer processor hardware to:
receive a first data packet including a first data payload, the first data packet transmitted for delivery to a destination network address;
determine a first latency classification assigned to the first data packet;
assign a second latency classification to the first data packet as a substitute to the first latency classification; and
forward the first data packet for delivery to the destination network address in accordance with the second latency classification.
